(19) United States
(12) Patent Application Publication
(10) Pub. No.: US 2024/0092547 A1
(43) Pub. Date: Mar. 21, 2024

(54) PACKAGING FILM AND PACKAGE

(71) Applicant: AMCOR FLEXIBLES NORTH AMERICA, INC., Neenah, WI (US)

(72) Inventors: Florian CHAPALAIN, Marcq-en-Baroeul (FR); Eliana ATRAMIZ, Bülach (CH); Francois BESSON, Illkirch-Graffenstaden (FR)

(21) Appl. No.: 18/273,390

(22) PCT Filed: Feb. 9, 2021
(86) PCT No.: PCT/US2021/017174

§ 371 Date: Jul. 20, 2023

(51) Int. Cl. B65D 65/40; B32B 27/08; B32B 27/32; B32B 33/00

(52) U.S. Cl. CPC B65D 65/40; B32B 27/08; B32B 27/32; B32B 33/00; B32B 2250/03; B32B 2250/24; B32B 2255/10; B32B 2307/31

(57) ABSTRACT

A recyclable packaging film and a package is disclosed. The packaging film includes a first surface including a first polyolefin-based polymer. The packaging film further includes a second surface including a second polyolefin-based polymer. The packaging film further includes a heat-resistant coating attached to the first surface. The heat-resistant coating is coextensive with less than 50%, by area, of the first surface of the packaging film. The package includes the packaging film and a heat seal connecting the second surface of the packaging film to a third surface.

### TECHNICAL FIELD

The present application relates generally to a packaging film, and particularly to a recyclable or recycle-ready packaging film with improved heat stability and heat resistance, and a package including the packaging film.

### BACKGROUND

Packaging films sometimes include a thin protective layer to improve optics, to protect printing layers, or to improve other functionalities of the packaging films. Most polymers used in the protective layer may have a thermoset nature which may not be ideal to combine with polyolefins or other polymeric material of the packaging film. Further, the polymers used in the protective layer may not be recyclable and may compromise the recyclability of the packaging films.

### SUMMARY

A package with improved heat stability and heat resistance has been developed which includes a packaging film.

Conventional packaging films may include a protective coating of a heat-resistant polymer applied on top of the packaging films, in order to improve the optics, other functionalities, such as controlled coefficient of friction (CoF) and scuff resistance, and/or to protect printing inks in a case of a surface printed configuration. Such protective coatings may include non-polyolefin-based coatings. In some cases, such protective coatings may include high temperature resistant thermosets or thermoplastics, for example, polyurethane, nitrocellulose, polyvinyl butyrate, or combinations thereof. The thermoset nature of such protective coatings may not be ideal to combine with polyolefins. Specifically, such protective coatings may not be recyclable when combined with recyclable polyolefins and may hinder near infrared (NIR) optical sorting commonly found in sorting and recycling centers located in various geographies, such as Europe. NIR optical sorting is generally used for identification and sorting of waste material in a recycling process. Protective coatings may hinder the polyolefin sorting process, unnecessarily removing an otherwise recyclable polyolefin-based packaging material.

Partial application of the heat-resistant coating only in the critical areas of the packaging film may reduce the amount of non-polyolefin-based polymers in the packaging film. This has the benefit of reducing the non-polyolefin-based polymer contamination in recycling streams. Thus, the packaging film having a reduced amount of non-polyolefin-based polymers may provide a better quality recyclate.

One embodiment of the present disclosure is a packaging film including a first surface, a second surface, and a heat-resistant coating. The first surface includes a first polyolefin-based polymer. The second surface includes a second polyolefin-based polymer. The heat-resistant coating is attached to the first surface. The heat-resistant coating is coextensive with less than 50%, by area, of the first surface of the packaging film.

The packaging film of present disclosure may include the heat-resistant coating only in critical areas including less than 50%, by area, of the first surface of the packaging film. Specifically, the heat-resistant coating may be present only in the critical areas which come in direct contact with hot sealing jaws under pressure during a typical heat-sealing process on packaging lines. Such partial application of the heat-resistant coating only in the critical areas of the packaging film may improve heat stability and heat resistance of the packaging film while retaining recycling properties of the packaging film. In other words, the packaging film of the present disclosure may limit the use of the heat-resistant coating, which may otherwise hinder the NIR optical sorting in the polyolefin recycling process, only in the critical areas of the packaging film while improving heat stability and heat resistance of the packaging film. Thus, the packaging film may be sorted in the appropriate stream. Further, such partial application of the heat-resistant coating only in the critical areas of the packaging film may reduce the amount of non-polyolefin-based polymers in the packaging film. This may further reduce non-polyolefin-based polymer contamination in recycling streams. Thus, the packaging film having a reduced amount of non-polyolefin-based polymers may provide a better quality recyclate.

In addition, as the heat-resistant coating is coextensive with less than 50%, by area, of the first surface of the packaging film, the packaging film may be easier to manufacture as it may require less heat-resistant coating for manufacture. This may also further reduce the cost of manufacturing of the packaging film.

Furthermore, as the heat-resistant coating is coextensive with less than 50%, by area, of the first surface of the packaging film, the stresses exerted on the packaging film during manufacture of the packaging film may be substantially reduced. Further, less heat may be required for drying the heat-resistant coating during the application of the heat-resistant coating to the packaging film. This may reduce strain and/or shrinkage of the packaging film. This may further allow usage of the heat-resistant coatings on polyolefin substrates having limited or low heat stability but providing better mechanical performance, such as puncture resistance, drop resistance, and/or toughness. Examples of such polyolefin substrates having limited heat stability include low density polyethylene (LDPE) and linear low-density polyethylene (LLDPE)-based biaxially oriented polyethylene (BOPE) films. Consequently, the heat-resistant coating of the present disclosure may enable the usage of such polyolefin substrates having limited heat stability in various packaging applications.

Another advantage of the partial application of the heat resistant coatings is that it may allow for lap sealing or an exterior layer sealing of the packaging film in any area that is not covered by the heat resistant coating.

In some embodiments, the packaging film includes a first polyethylene-based film including the first surface.

In some embodiments, the packaging film includes a first oriented polyethylene-based film including the first surface.

In some embodiments, the packaging film includes a first polypropylene-based film including the first surface.

In some embodiments, the packaging film includes a first oriented polypropylene-based film including the first surface.

In some embodiments, the second polyolefin-based polymer is a second polyethylene-based polymer or a second polypropylene-based polymer.

In some embodiments, the second polyolefin-based polymer of the second surface is a polyethylene-based polymer having a heat seal initiation temperature (HSIT) less than 110° C.

In some embodiments, the second polyolefin-based polymer of the second surface is a polypropylene-based polymer having a HSIT less than 140° C.

In some embodiments, the total composition of the packaging film is at least 80% polyolefin-based polymer, by weight.

In some embodiments, the heat-resistant coating has a dry coat weight of between 0.5-4.0 grams per square meter (g/m²).

In some embodiments, the packaging film further includes an internal layer including a high-density polyethylene polymer.

In some embodiments, the packaging film further includes an internal layer including a barrier material. The barrier material may be one or more of polyamide-based polymer, cyclic olefin copolymer, ethylene vinyl alcohol copolymer, acrylic, polyvinyl alcohol copolymer, metal, aluminum oxide, and silicon oxide.

Another embodiment of the present disclosure is a package including the packaging film and a heat seal. The heat seal connects the second surface of the packaging film to a third surface.

In some embodiments, the packaging film further includes a heat seal area defined by the heat seal and the heat-resistant coating is coextensive with at least 75% of the heat seal area.

In some embodiments, the packaging film further includes a heat seal area defined by the heat seal and the heat-resistant coating is coextensive with at least 90% the heat seal area.

In some embodiments, the heat-resistant coating is located over some of the heat seals but is not located over other heat seals. For example, in a flow-wrap style package, the heat-resistant coating may be coextensive with the transverse direction end seals but may not be present in the location of the longitudinal direction fin seal. In these embodiments, the packaging film the heat-resistant coating is coextensive with a lower amount of the heat seal area, such as less than 75%, or less than 50% or even less than 25%.

Another embodiment of the present disclosure is a package. The package includes a packaging film including a first surface, a second surface, a heat seal area, and a heat-resistant coating. The first surface includes a first polyolefin-based polymer. The second surface includes a second polyolefin-based polymer. The heat seal area is defined by a heat seal. The heat seal connects the second surface of the packaging film to a third surface. The heat-resistant coating is attached to the first surface and at least partially coextensive with the heat seal area.

In some embodiments, the heat-resistant coating attached to the first surface is coextensive with more than 75% of the heat seal area of the packaging film. Further, the heat-resistant coating is coextensive with less than 50%, by area, of the first surface of the packaging film.

In some embodiments, the package has a pillow bag configuration, and the third surface is the second surface of the packaging film.

In some embodiments, the third surface is included in a second packaging component.

In some embodiments, the total composition of the packaging film is at least 80% polyolefin-based polymer, by weight.

There are several other aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1A illustrates a cross-sectional view of a packaging film in accordance with an embodiment of the present disclosure;

FIG. 1B illustrates a top view of the packaging film;

FIG. 1C illustrates a top view of multiple packaging films in a packaging line;

FIG. 2 illustrates a cross-sectional view of another packaging film in accordance with another embodiment of the present disclosure;

FIG. 3 illustrates a cross-sectional view of another packaging film in accordance with another embodiment of the present disclosure;

FIG. 4 illustrates a cross-sectional view of another packaging film in accordance with another embodiment of the present disclosure;

FIG. 5 illustrates a cross-sectional view of another packaging film in accordance with another embodiment of the present disclosure;

FIG. 6 illustrates a cross-sectional view of another packaging film in accordance with another embodiment of the present disclosure;

FIG. 7A illustrates a schematic perspective view of a package in accordance with an embodiment of the present disclosure;

FIG. 7B illustrates a cross sectional view of the package of FIG. 7A;

FIG. 7C illustrates an enlarged view of a portion of the package of FIG. 7B;

FIG. 8 illustrates a schematic view of another package in accordance with another embodiment of the present disclosure;

FIG. 9 illustrates a schematic perspective view of another package in accordance with another embodiment of the present disclosure;

FIG. 10A illustrates a schematic perspective view of another package in accordance with another embodiment of the present disclosure;

FIG. 10B illustrates is a cross-sectional view of the package of FIG. 10A;

FIG. 11 is a graph illustrating dynamic coefficient of friction (CoF) of packaging films including different heat-resistant coatings;

FIG. 12 is a graph illustrating sealing temperature windows of packaging films including different heat-resistant coatings;

FIG. 13 is a graph illustrating dynamic coefficient of friction (CoF) of a packaging film including a heat-resistant coating; and

FIG. 14 is a graph illustrating sealing temperature windows of a packaging film without a heat-resistant coating and the packaging film including a heat-resistant coating.

The figures are not necessarily to scale. Like numbers used in the figures refer to like components. It will be understood, however, that the use of a number to refer to a component in a given figure is not intended to limit the component in another figure labeled with the same number.

The drawings show some but not all embodiments. The elements depicted in the drawings are illustrative and not necessarily to scale, and the same (or similar) reference numbers denote the same (or similar) features throughout the drawings.

### DETAILED DESCRIPTION

The present disclosure relates to a packaging film including a first surface, a second surface, and a heat-resistant coating. The first surface includes a first polyolefin-based polymer. The second surface includes a second polyolefin-based polymer. The heat-resistant coating is attached to the first surface. The heat-resistant coating is coextensive with less than 50%, by area, of the first surface of the packaging film. The present disclosure further relates to a package including the packaging film.

Conventional packaging films may include a protective coating of a heat-resistant polymer applied on top of the packaging films, in order to improve the optics, other functionalities, such as controlled coefficient of friction (CoF) and scuff resistance, and/or to protect printing inks in a case of a surface printed configuration. Such protective coatings may include non-polyolefin-based coatings. In some cases, such protective coatings may include thermosets and thermoplastics, for example, polyurethane, nitrocellulose, polyvinyl butyrate, or combinations thereof. The thermoset nature of such protective coatings may not be ideal to combine with polyolefins. Specifically, such protective coatings may not be recyclable when combined with recyclable polyolefins and may hinder near infrared (NIR) optical sorting commonly found in sorting and recycling centers located in various geographies, such as Europe. The NIR optical sorting is generally used for identification and sorting of waste material in a recycling process. Therefore, such protective coatings may hinder polyolefin sorting. Further, such partial application of the heat-resistant coating only in the critical areas of the packaging film may reduce the amount of non-polyolefin-based polymers in the packaging film. This may further reduce non-polyolefin-based polymer contamination in recycling streams. Thus, the packaging film having a reduced amount of non-polyolefin-based polymers may provide a better quality recyclate.

The packaging film of present disclosure includes the heat-resistant coating only in critical areas including less than 50%, by area, of the first surface of the packaging film. Specifically, the heat-resistant coating may be present only in the critical areas which come in direct contact with hot sealing jaws under pressure during a typical heat-sealing process on packaging lines. Such partial application of the heat-resistant coating only in the critical areas of the packaging film may improve heat stability and heat resistance of the packaging film while retaining recycling properties of the packaging film. In other words, the packaging film of the present disclosure may limit the use of the heat-resistant coating, which may otherwise hinder the NIR optical sorting in the polyolefin recycling process, only in the critical areas of the packaging film while improving the heat stability and heat resistance of the packaging film. Thus, the packaging film may be sorted to the appropriate recycling stream.

Further, such partial application of the heat-resistant coating only in the critical areas of the packaging film may reduce the amount of non-polyolefin-based polymers in the packaging film. This may further reduce non-polyolefin-based polymer contamination in recycling streams. Thus, the packaging film having a reduced amount of non-polyolefin-based polymers may provide a better quality recyclate.

In addition, as the heat-resistant coating is coextensive with less than 50%, by area, of the first surface of the packaging film, the packaging film may be easier to manufacture as it may require less heat-resistant coating for manufacture of the packaging film. This may also further reduce the cost of manufacturing of the packaging film.

Furthermore, as the heat-resistant coating is coextensive with less than 50%, by area, of the first surface of the packaging film, the stresses exerted on the packaging film during manufacture of the packaging film may be substantially reduced. Further, less heat may be required for drying the heat-resistant coating during the coating process if the heat-resistant coating is applied via a water- or solvent-based solution. This may reduce strain and/or shrinkage of the packaging film. This may further allow usage of the heat-resistant coatings on polyolefin substrates having limited or low heat stability but providing better mechanical performance, such as puncture resistance, drop resistance, or toughness. Examples of such polyolefin substrates having limited heat stability include low density polyethylene (LDPE) or linear low-density polyethylene (LLDPE)-based biaxially oriented polyethylene (BOPE) films. Consequently, the heat-resistant coating of the present disclosure may enable the usage of such polyolefin substrates having limited heat stability in various packaging applications.

The packaging films of the present disclosure may further allow a lap sealing or an exterior layer sealing of the different layers of the packaging film without the use of any additional heat-sealing polymer.

As used in the present disclosure, the term “film” is a material with a very high ratio of length or width to thickness. A film has two major surfaces defined by a length and width. Films typically have good flexibility and can be used for a wide variety of applications, including flexible packaging. Films may also be of thickness and/or material composition such that they are semi-rigid or rigid. Films described in the present disclosure are composed of various polymeric materials but may also contain other materials, such as metals or papers. Films may be described as monolayer or multilayer.

As used in the present disclosure, the term “layer” refers to a thickness of material within a film that has a relatively consistent formula. Layers may be of any type of material including polymeric, cellulosic, and metallic or a blend thereof. A given polymeric layer may consist of a single polymer-type or a blend of polymers and may be accompanied by additives. A given layer may be combined or connected to other layers to form films. A layer may be either partially or fully continuous as compared to adjacent layers or the film. A given layer may be partially or fully coextensive with adjacent layers. A layer may contain sub-layers.

As used in the present disclosure, the term “internal layer” refers to a layer of a film structure which does not reside on either major exterior surface of the film. An internal layer may consist of a single layer or may be multi-layered. There may be one or more internal layers in a film.

As used in the present disclosure, the term “package” refers to any article or combination of articles used to surround an item wholly or partially. A package may take many, various forms. For example, the term “package” may include bags that wholly surround an item (or items) to be packaged; the term “package” may also include films that partially surround an item (or items) to be packaged and, when used in conjunction with another material (such as a tray), wholly surround an item (or items).

As used in the present disclosure, the term “oriented” refers to a monolayer or multilayer film, sheet, or web which has been elongated in at least one of the machine direction or the transverse direction. Such elongation is accomplished by procedures known to a person of ordinary skill in the art. Non-limiting examples of such procedures include the single bubble blown film extrusion process and the slot case sheet extrusion process with subsequent stretching, for example, by tentering, to provide orientation. Another example of such procedure is the trapped bubble or double bubble process. (See, for example, U.S. Pat. Nos. 3,546,044 and 6,511,688, each of which is incorporated in its entirety in this application by this reference.) In the trapped bubble or double bubble process, an extruded primary tube leaving the tubular extrusion die is cooled, collapsed, and then oriented by reheating, reinflating to form a secondary bubble and recooling. Transverse direction orientation may be accomplished by inflation, radially expanding the heated film tube. Machine direction orientation may be accomplished by the use of nip rolls rotating at different speeds, pulling, or drawing the film tube in the machine direction. The combination of elongation at elevated temperature followed by cooling causes an alignment of the polymer chains to a more parallel configuration, thereby improving the mechanical properties of the film, sheet, web, package or otherwise. Upon subsequent heating of an unrestrained, unannealed, oriented article to its orientation temperature, heat-shrinkage (as measured in accordance with ASTM Test Method D2732, “Standard Test Method for Unrestrained Linear Thermal Shrinkage of Plastic Film and Sheeting,” which is incorporated in its entirety in this application by this reference) may be produced. Heat-shrinkage may be reduced if the oriented article is annealed or heat-set by heating to an elevated temperature, preferably to an elevated temperature which is above the glass transition temperature and below the crystalline melting point of the polymer comprising the article. This reheating/annealing/heat-setting step also provides a polymeric web of uniform flat width. The polymeric web may be annealed (i.e., heated to an elevated temperature) either in-line with (and subsequent to) or off-line from (in a separate process) the orientation process.

As used in the present disclosure, the term “non-oriented” refers to a monolayer or multilayer film, sheet or web that is substantially free of post-formation orientation.

As used in the present disclosure, the term “gloss” refers to the shiny appearance of a material. It is a measure of the light reflected by the surface of a material and is measured at a specific angle of reflection (20, 45, 60, 75, or 85 degrees) against a specific backing. Gloss may be determined in accordance with ASTM D2457-90 (“Standard Test Method for Specular Gloss of Plastic Films and Solid Plastics”). Gloss values are reported in Gloss Units. A high gloss value generally indicates a material that is shinier.

The term “polymeric adhesive layer”, “adhesive layer”, or “tie layer”, refers to a layer or material placed in or on one or more layers to promote the adhesion of that layer to another surface. Preferably, adhesive layers are positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may include components of both the first layer and the second layer to promote simultaneous adhesion of the adhesive layer to both the first layer and the second layer to opposite sides of the adhesive layer.

As used in the present disclosure, “polyolefin” refers to polyethylene homopolymers, polyethylene copolymers, polypropylene homopolymers or polypropylene copolymers.

As used in the present disclosure, “polyethylene” refers to polymers that include an ethylene linkage. Polyethylenes may be a homopolymer or copolymer. Polyethylene copolymers may include other types of polymers (i.e., non-polyethylene comonomers). Polyethylenes may have functional groups incorporated by grafting or other means. Polyethylenes include, but are not limited to, low-density polyethylene (LDPE), linear low density polyethylene (LLDPE), medium-density polyethylene (MDPE), ultra-low density polyethylene (ULDPE), high-density polyethylene (HDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

As used in the present disclosure, “polypropylene” refers to polymers that are derived from monomers of propylene. Polypropylenes may be a homopolymer or copolymer. Polypropylene copolymers may include other types of polymers (i.e., non-polypropylene comonomers). Polypropylenes may have functional groups incorporated by grafting or other means. Polypropylenes include, but are not limited to, propylene-ethylene copolymers, ethylene-propylene copolymers, and maleic anhydride grafted polypropylenes (MAHgPP).

As used herein, the term “coextensive” refers to two components, surfaces, films, or layers having the same spatial or temporal scope, or the same boundaries.

As used herein, the term “dry coat weight” refers to a weight per unit area (e.g., g/m²) of a coating or a layer.

As used herein, the term “heat-sealing” refers to sealing opposing portions of film (at lap seal interface or at the end seal interface) with heat.

As used herein, the term “heat seal” refers to the formation of a fusion bond between two polymer surfaces by conventional heating means.

As used in the present disclosure, the term “heat seal area” refers to a specific contact area where two polymer surfaces are heat sealed. The specific contact area comes in direct contact with the hot sealing jaws during a heat-sealing process.

As used in the present disclosure, the term “heat-sealing process” refers to a process of sealing two polymer surfaces using heat and pressure. A direct contact method of heat-sealing utilizes a constantly heated die or sealing jaws to apply heat to a specific contact area or path to seal or weld the two polymer surfaces together. Heat-sealing is used for many applications, including heat seal connectors, thermally activated adhesives, film media, plastic ports, or foil sealing. The direct contact method of heat-sealing may use one or more heated bars, irons, dies, or jaws which contact the material to heat an interface and form a bond. The bars, irons, dies ad jaws have various configurations and may be covered with a release layer or utilize various slick interposer materials (i.e., Teflon films) to prevent sticking to a hot tooling during the heat-sealing process.

As used in the present disclosure, the term “recyclate” or “recycled” refers to a polymer-based material being used to form a new article (e.g. a film or a layer of a film), the polymer-based material having been previously formed into a product (e.g., film) by an extrusion process. The recyclate may be used in an extrusion process to produce the new article. The recyclate may be subjected to other processing steps, such as pelletization, between the extrusion that formed the initial product and the extrusion step that now uses the recyclate. The recyclate may be blended with other non-recycled polymer materials.

As used in the present disclosure, the term “coating process” refers to a process of coating a material on a substrate.

As used in the present disclosure, the term “seal strength” refers to a tensile strength of a seal at ambient temperature. It is the maximum force required to separate two layers of the seal under specific conditions. A series of seals at different sealing temperatures may be made, using a machine employing sealing jaws.

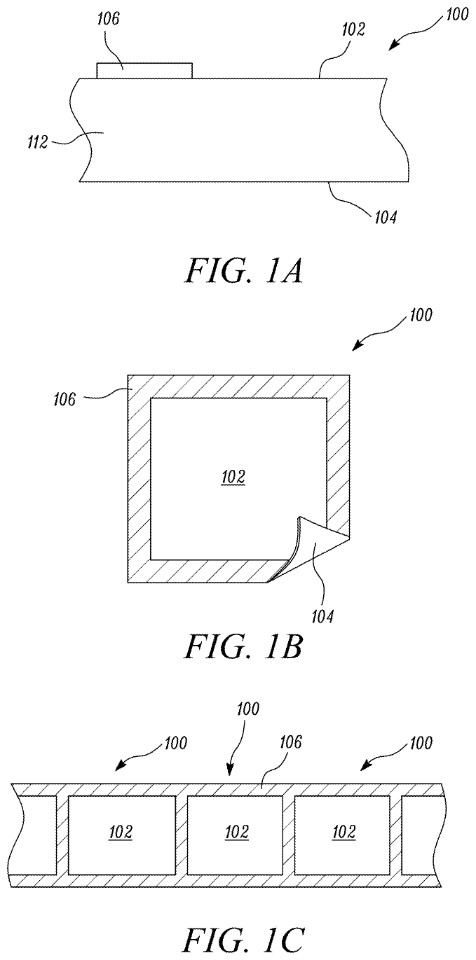

FIG. 1A shows a cross-sectional view of a packaging film 100 in accordance with an embodiment of the present disclosure. FIG. 1B is a top view of packaging film 100 of FIG. 1A. FIG. 1C is a top view of multiple packaging films 100 of FIG. 1A connected to each other in a row, as they may be produced and supplied (i.e. roll format).

Referring to FIGS. 1A-1C, packaging film 100 includes a first surface 102 and a second surface 104. In the illustrated embodiment of FIGS. 1A-1C, second surface 104 is opposite to first surface 102. First surface 102 includes a first polyolefin-based polymer.

In some embodiments, the first polyolefin-based polymer may be a linear low-density polyethylene.

In some embodiments, packaging film 100 includes a first polyethylene-based film including first surface 102. In some embodiments, packaging film 100 includes a first oriented polyethylene-based film including first surface 102. In some embodiments, the first oriented polyethylene-based film may be biaxially or machine direction oriented. In other words, the first oriented polyethylene-based film includes a biaxially-oriented polyethylene (BOPE) or a machine direction-oriented polyethylene (MDOPE).

In some embodiments, packaging film 100 includes a first polypropylene-based film including first surface 102. In some embodiments, packaging film 100 includes a first oriented polypropylene-based film including first surface 102. In some embodiments, the first oriented polypropylene-based film may be biaxially or machine direction oriented. In other words, the first oriented polypropylene-based film includes a biaxially-oriented polypropylene (BOPP) or a machine direction-oriented polypropylene (MDOPP).

Second surface 104 includes a second polyolefin-based polymer. In some embodiments, the second polyolefin-based polymer is a second polyethylene-based polymer or a second polypropylene-based polymer. In some embodiments, the second polyolefin-based polymer may include a cast polypropylene (CPP).

In some embodiments, the second polyolefin-based polymer of second surface 104 is a polyethylene-based polymer having a heat seal initiation temperature (HSIT) less than 110° C. In some other embodiments, the second polyolefin-based polymer of second surface 104 is a polypropylene-based polymer having the HSIT less than 140° C. The HSIT may be a temperature at which a seal strength is 5.25 Newton (N)/15 millimeter (mm) as will be further described

The HSIT point of a polymer in a sealing surface of a film is generally regarded as the minimum temperature of a heat seal bar that influences a film being sealed to form a critical bond level. To determine a HSIT of a polymer in a sealing surface of a film, the film is subjected to standard heat-seal testing according to ASTM F88 “Standard Test Method for Seal Strength”. Using this test method, a film is placed in a heat sealing unit with the sealing surface placed in contact with the sealing surface of the same film (i.e. face-to-face). A pressure of 400 N/20 cm² and a specified temperature (both seal bars heated) are used to create a heat seal during a sealing cycle of 0.5 seconds. When the seal has cooled to room temperature, a 15 mm width sample is cut from the seal and the sample is loaded into a tensile testing unit. The force required to separate the films at the seal (i.e. seal strength) is measured using a separation velocity of 300 mm/min. The film is tested by this method at various heat seal temperatures approaching the temperature at which no seal is formed. The seal strength at various heat seal temperatures can be plotted on a graph and the resulting curve can be extrapolated to determine the temperature at which the seal strength would be approximately 5.25 Newton (N)/15 millimeter (mm). This temperature is the HSIT.

In some embodiments, the total composition of packaging film 100 is at least 80% polyolefin-based polymer, by weight. In some embodiments, the total composition of packaging film 100 is at least 90%, or at least 95% polyolefin-based polymer, by weight.

Packaging film 100 further includes a heat-resistant coating 106 attached to first surface 102. Heat-resistant coating 106 is coextensive with a portion of first surface 102 of packaging film 100. In other words, heat-resistant coating 106 and the portion of first surface 102 have the same spatial or temporal scope, or the same boundaries. Further, heat-resistant coating 106 has an area that is less than an area of first surface 102. As is apparent from FIGS. 1A-1C, heat-resistant coating 106 is coextensive with less than 50%, by area, of first surface 102 of packaging film 100. In some embodiments, heat-resistant coating 106 is coextensive with less than 40%, 30%, 25%, 20%, or 10%, by area, of first surface 102 of packaging film 100. In other words, heat-resistant coating 106 of packaging film 100 is applied to only a portion (i.e., less than 50% by area) of first surface 102. In some embodiments, packaging film 100 includes heat-resistant coating 106 along a periphery or borders of packaging film 100. In some embodiments, heat-resistant coating 106 may have a dry coat weight greater than 0.5 grams per square meter (g/m²), greater than 0.4 g/m², greater than 0.3 g/m², or greater than 0.2 g/m². In some other embodiments, heat-resistant coating 106 may have a dry coat weight less than 4.0 g/m², less than 4.5 g/m², less than 5.0 g/m², less than 5.5 g/m², less than 6.0 g/m², less than 6.5 g/m², or less than 7.0 g/m². For example, in some embodiments, heat-resistant coating 106 has a dry coat weight of between 0.5-4.0 g/m². In some embodiments, heat-resistant coating 106 has a dry coat weight of between 0.3 g/m² and 6.0 g/m².

In some embodiments, heat-resistant coating 106 may include a combination of one or more of polyurethane, nitrocellulose, acrylate, polyvinyl butyral (PVB), and copolymers of these. In some other embodiments, heat-resistant coating 106 may include other polymers which are cross linkable using ultraviolet (UV) light and electron beam (EB). In some embodiments, heat-resistant coating 106 may be glossy or matte. In some embodiments, heat-resistant coating 106 may be pigmented or unpigmented. In some embodiments, heat-resistant coating 106 may provide a glossy or matte finish to packaging film 100. In some examples, heat-resistant coating 106 may include one or more of 9W8200203, SYSTS200, SYSTS457, and SYSTS410 (commercially available from Sun Chemical Ltd, UK). In some other examples, heat-resistant coating 106 may include one or more of BG 2K 100, H HARDENER 10-600014-4.1570, and H HARDENER 10-600015-1.1620 (commercially available from Siegwerk Belgium N.V.). In some other examples, heat-resistant coating 106 may include a two-component system such as a blend of Herberts-GL 3335 and hardener GU106 (commercially available from Bostik SA).

In some embodiments, packaging film 100 further includes an internal layer 112. In some embodiments, internal layer 112 includes a high-density polyethylene (HDPE) polymer. In some embodiments, internal layer 112 includes a BOPP.

In some embodiments, internal layer 112 includes a barrier material. In some embodiments, the barrier material includes one or more of polyamide-based polymer, cyclic olefin copolymer, ethylene vinyl alcohol copolymer, acrylic, polyvinyl alcohol copolymer, metal, aluminum oxide, and silicon oxide. The barrier material may be used to prevent or inhibit leakage of a product packaged using packaging film 100, to retain odor of the product within packaging film 100, and/or to prevent or inhibit ingress or egress of any substance which can potentially deteriorate the quality of the product. In some embodiments, packaging film 100 may include more than one internal layer 112.

In some embodiments, internal layer 112 may include one or more adhesive layers to attach the first polyolefin-based polymer and the second polyolefin-based polymer together. In some embodiments, the adhesive layers may further attach one or more sub-layers of internal layer 112 together. In some embodiments, the adhesive layers may include a dry bond adhesive or an extruded bonding layer.

In some embodiments, internal layer 112 may further include an ink layer. As used in the present disclosure, the term “ink” refers to an opaque or translucent material formulated to bond to a film, such as the ink layer. Inks include, for example, solvent-based inks, water-based inks, electron-beam-curing inks, ultraviolet-curing inks, and two-part inks. The ink layer may be used for advertising, for labelling, or for including graphics, promotional or useful information about packaging film 100 or the product packaged using packaging film 100. The ink layer may be patterned (i.e. not fully coextensive with the internal layer 112) or flood coated (i.e. coextensive with the internal layer 112).

In some other embodiments, packaging film 100 may include a pigmented ink deposited on first surface 102 of packaging film 100. The ink layer located on the first surface 102 of packaging film 100 may be patterned (i.e. not fully coextensive with the internal layer 112) or flood coated (i.e. coextensive with the internal layer 112). The ink layer may be intervening between the heat-resistant coating 106 and the first surface 102. In other words, the heat-resistant coating 106 is attached to the first surface 102 by way of the ink layer.

In the illustrated embodiment of FIG. 1B, heat-resistant coating 106 is disposed on the borders or the periphery of first surface 102. Further, heat-resistant coating 106 has a closed shape. In some other embodiments, heat-resistant coating 106 may have an open shape. In such cases, heat-resistant coating 106 may be disposed along a portion of the periphery of first surface 102. Further, in some other embodiments, heat-resistant coating 106 may be spaced apart from the borders or the periphery of first surface 102. In some embodiments, heat-resistant coating 106 may be disposed in a pattern on first surface 102. In some embodiments, heat-resistant coating 106 may be disposed in one or more suitable shapes or arrangements on first surface 102, for example, rectangular shapes, triangular shapes, polygonal shapes, circular shapes, elliptical shapes, irregular shapes, zig-zag arrangement, curvilinear arrangement, and so forth.

In the illustrated embodiment of FIG. 1C, multiple packaging films 100 are disposed adjacent to each other in the packaging line. Adjacent packaging films 100 are joined to each other to form a continuous arrangement of packaging films 100. Heat-resistant coating 106 extends along multiple packaging films 100. In some cases, multiple packaging films 100 may be sequentially or simultaneously heat sealed at least along heat-resistant coating 106. Heat-sealing may occur after the product is received within each packaging film 100. Each packaging film 100 may be detached from adjacent packaging films 100 before or after the heat-sealing. Packaging films 100 may have substantially similar or different configurations based on application requirements.

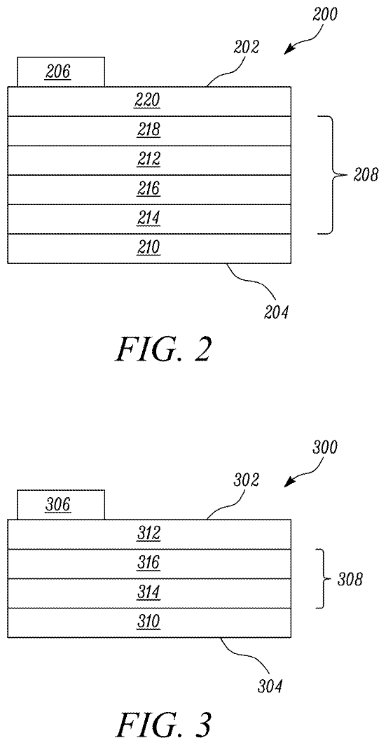

FIG. 2 is a cross-sectional view of a packaging film 200 in accordance with an embodiment of the present disclosure. Packaging film 200 is equivalent to packaging film 100 shown in FIGS. 1A-1C. Packaging film 200 includes a first surface 202 and a second surface 204. In the illustrated embodiment of FIG. 2, second surface 204 is opposite to first surface 202. First surface 202 includes the first polyolefin-based polymer and second surface 204 includes the second polyolefin-based polymer. In some embodiments, the first polyolefin-based polymer is a polypropylene. In some embodiments, the second polyolefin-based polymer is a polyethylene-based polymer. Packaging film 200 further includes a heat-resistant coating 206 attached to first surface 202. Heat-resistant coating 206 is coextensive with less than 50%, by area, of first surface 202 of packaging film 200. Packaging film 200 includes a first layer 220 including first surface 202. In some embodiments, first layer 220 includes the first polyolefin-based polymer. In some embodiments, first layer 220 is a BOPP film. Packaging film 200 includes a second layer 210 including second surface 204. In some embodiments, second layer 210 includes the second polyolefin-based polymer. In the illustrated embodiment of FIG. 2, packaging film 200 further includes multiple internal layers 208. Internal layers 208 of packaging film 200 includes a first internal layer 218 disposed on first layer 220 opposite to first surface 202. First internal layer 218 includes the ink layer. Internal layers 208 of packaging film 200 further includes a second internal layer 212 disposed on first internal layer 218 opposite to first layer 220. Second internal layer 212 includes the adhesive layer. Internal layers 208 of packaging film 200 further includes a third internal layer 216 disposed on second internal layer 212 opposite to first internal layer 218. Third internal layer 216 is another BOPP film. Internal layers 208 of packaging film 200 further includes a fourth internal layer 214 disposed on third internal layer 216 opposite to second internal layer 212. Fourth internal layer 214 includes the adhesive layer.

FIG. 3 is a cross-sectional view of a packaging film 300 in accordance with another embodiment of the present disclosure. Packaging film 300 is equivalent to packaging film 100 shown in FIGS. 1A-1C. Packaging film 300 includes a first surface 302 and a second surface 304. In the illustrated embodiment of FIG. 3, second surface 304 is opposite to first surface 302. First surface 302 includes the first polyolefin-based polymer and second surface 304 includes the second polyolefin-based polymer. In some embodiments, the first polyolefin-based polymer is a polypropylene. In some embodiments, the second polyolefin-based polymer is a CPP. Packaging film 300 further includes a heat-resistant coating 306 attached to first surface 302. Heat-resistant coating 306 is coextensive with less than 50%, by area, of first surface 302 of packaging film 300. Packaging film 300 includes a first layer 312 including first surface 302. In some embodiments, first layer 312 includes the first polyolefin-based polymer. In some embodiments, first layer 312 is a BOPP film. Packaging film 300 includes a second layer 310 including second surface 304. In some embodiments, second layer 310 includes the second polyolefin-based polymer. In the illustrated embodiment of FIG. 3, packaging film 300 further includes multiple internal layers 308. Internal layers 308 of packaging film 300 includes a first internal layer 316 disposed on first layer 312 opposite to first surface 302. First internal layer 316 includes the ink layer. Internal layers 308 of packaging film 300 further includes a second internal layer 314 disposed on first internal layer 316 opposite to first layer 312. Second internal layer 314 includes the adhesive layer.

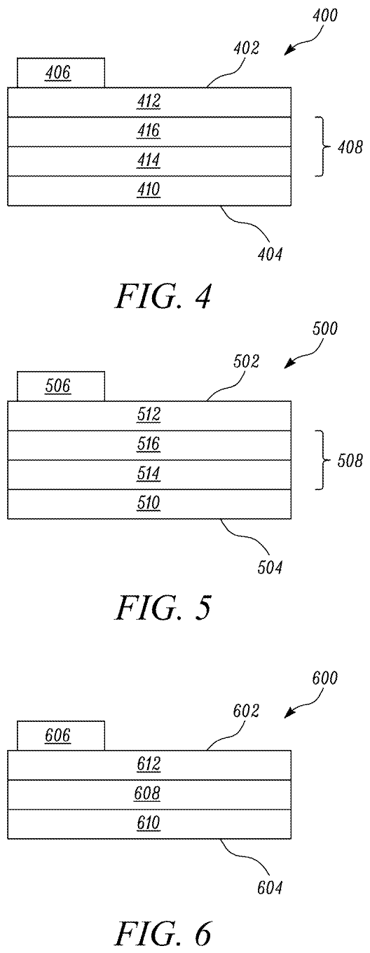

FIG. 4 is a cross-sectional view of a packaging film 400 in accordance with another embodiment of the present disclosure. Packaging film 400 is equivalent to packaging film 100 shown in FIGS. 1A-1C. Packaging film 400 includes a first surface 402 and a second surface 404. In the illustrated embodiment of FIG. 4, second surface 404 is opposite to first surface 402. First surface 402 includes the first polyolefin-based polymer and second surface 404 includes the second polyolefin-based polymer. In some embodiments, the first polyolefin-based polymer is a polyethylene. In some embodiments, the second polyolefin-based polymer is a polyethylene-based polymer. Packaging film 400 further includes a heat-resistant coating 406 attached to first surface 402. Heat-resistant coating 406 is coextensive with less than 50%, by area, of first surface 402 of packaging film 400. Packaging film 400 includes a first layer 412 including first surface 402. In some embodiments, first layer 412 includes the first polyolefin-based polymer. In some embodiments, first layer 412 is a MDOPE film. Packaging film 400 includes a second layer 410 including second surface 404. In some embodiments, second layer 410 includes the second polyolefin-based polymer. In the illustrated embodiment of FIG. 4, packaging film 400 further includes multiple internal layers 408. Internal layers 408 of packaging film 400 includes a first internal layer 416 disposed on first layer 412 opposite to first surface 402. First internal layer 416 includes the ink layer. Internal layers 408 of packaging film 400 further includes a second internal layer 414 disposed on first internal layer 416 opposite to first layer 412. Second internal layer 414 includes the adhesive layer.

FIG. 5 is a cross-sectional view of a packaging film 500 in accordance with another embodiment of the present disclosure. Packaging film 500 is equivalent to packaging film 100 shown in FIGS. 1A-1C. Packaging film 500 includes a first surface 502 and a second surface 504. In the illustrated embodiment of FIG. 5, second surface 504 is opposite to first surface 502. First surface 502 includes the first polyolefin-based polymer and second surface 504 includes the second polyolefin-based polymer. In some embodiments, the first polyolefin-based polymer is a polyethylene. In some embodiments, the second polyolefin-based polymer is a polyethylene-based polymer. Packaging film 500 further includes a heat-resistant coating 506 attached to first surface 502. Heat-resistant coating 506 is coextensive with less than 50%, by area, of first surface 502 of packaging film 500. Packaging film 500 includes a first layer 512 including first surface 502. In some embodiments, first layer 512 includes the first polyolefin-based polymer. In some embodiments, first layer 512 is a BOPE film. Packaging film 500 includes a second layer 510 including second surface 504. In some embodiments, second layer 510 includes the second polyolefin-based polymer. In the illustrated embodiment of FIG. 5, packaging film 500 further includes multiple internal layers 508. Internal layers 508 of packaging film 500 includes a first internal layer 516 disposed on first layer 512 opposite to first surface 502. First internal layer 516 includes the ink layer. Internal layers 508 of packaging film 500 further includes a second internal layer 514 disposed on first internal layer 516 opposite to first layer 512. Second internal layer 514 includes a polyethylene lamination layer. In some embodiments, the polyethylene lamination layer may act as the adhesive layer and can be applied via an extrusion lamination process.

FIG. 6 is a cross-sectional view of a packaging film 600 in accordance with another embodiment of the present disclosure. Packaging film 600 is equivalent to packaging film 100 shown in FIGS. 1A-1C. Packaging film 600 includes a first surface 602 and a second surface 604. In the illustrated embodiment of FIG. 6, second surface 604 is opposite to first surface 602. First surface 602 includes the first polyolefin-based polymer and second surface 604 includes the second polyolefin-based polymer. In some embodiment, the first polyolefin-based polymer is a polyethylene. In some embodiments, the second polyolefin-based polymer is a polyethylene coating. Packaging film 600 further includes a heat-resistant coating 606 attached to first surface 602. Heat-resistant coating 606 is coextensive with less than 50%, by area, of first surface 602 of packaging film 600. Packaging film 600 includes a first layer 612 including first surface 602. In some embodiments, first layer 612 includes the first polyolefin-based polymer. Packaging film 600 includes a second layer 610 including second surface 604. In some embodiments, first layer 612 is a BOPE film. In some embodiments, second layer 610 includes the second polyolefin-based polymer. In the illustrated embodiment of FIG. 6, packaging film 600 further includes an internal layer 608. Internal layer 608 of packaging film 600 is disposed on first layer 612 opposite to first surface 602. Further, internal layer 608 is disposed between first layer 612 and second layer 610. Internal layer 608 includes the ink layer.

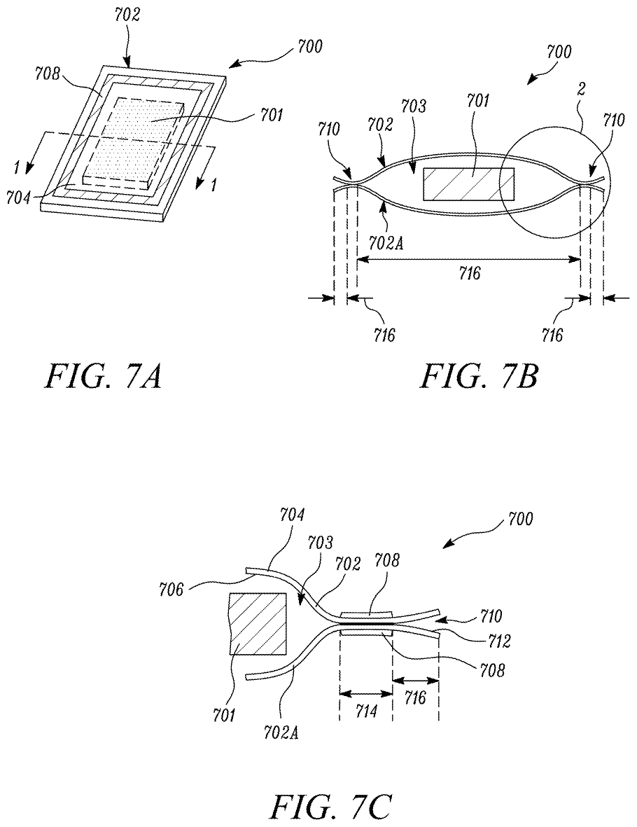

FIG. 7A is a schematic view of a package 700 in accordance with an embodiment of the present disclosure. FIG. 7B is a cross sectional view of package 700, taken generally along line 1-1 of FIG. 7A. FIG. 7C is an enlarged view of a portion of package 700, taken generally along circle 2 of FIG. 7B.

In the illustrated embodiment of FIGS. 7A-7C, package 700 is a sachet or 4-side-seal pouch. In some other embodiments, package 700 may be a pouch, a bag, a flow-wrap, or a pillow package and may include fitments like zippers or spouts. In the illustrated embodiment of FIGS. 7A-7C, package 700 has a rectangular shape. However, in some other embodiments, package 700 may include a circular shape, an oval shape, a triangular shape, a polygonal shape, and so on. In some embodiments, package 700 may have a pillow bag configuration, a cup-lid configuration, or any other configuration. Package 700 may take any number of forms including pouches, bags, trays/lids, clamshells, or flow-wraps.

Package 700 is used to contain a product 701 in a primary product cavity 703. In some embodiments, package 700 may include food product or pharmaceutical product stored in primary product cavity 703. In some embodiments, package 700 may include beverages or nutraceutical products. In some embodiments, product 701 may include liquids, particles, powders, solids, or combinations thereof. The liquids may include liquid food items (e.g., juice), liquid surfactants, paints, etc. The particles may include particulate food items (e.g., cereal), paint particles, detergent particles, etc. The powder may include detergent powders, cosmetics, paint powders, powdered food items (e.g., powdered sugar), etc. In some other embodiments, product 701 may be, but is not limited to, a personal care product, a pet food, a medical product, a pharmaceutical product, a first aid product, a nutritional aid product, or a beverage.

In the illustrated embodiment of FIG. 7A, package 700 includes a packaging film 702. However, in some examples, package 700 may include any one of packaging films 100, 200, 300, 400, 500, 600 (shown in FIGS. 1A-1C to 6).

In some embodiments, packaging film 702 is equivalent to packaging film 100 (shown in FIGS. 1A-1C). Packaging film 702 includes a first surface 704 and a second surface 706. First surface 704 includes the first polyolefin-based polymer and second surface 706 includes the second polyolefin-based polymer. Packaging film 702 further includes a heat-resistant coating 708 attached to first surface 704. As is apparent from the illustrated embodiment of FIGS. 7A-7C, heat-resistant coating 708 is coextensive with less than 50%, by area, of first surface 704 of packaging film 702.

In the illustrated embodiments of FIGS. 7A-7C, package 700 includes a heat seal 710. Packaging film 702 further includes a heat seal area 714 defined by heat seal 710. Packaging film 702 further includes a non-heat seal area 716 defined by primary product cavity 703. In some embodiments, non-heat seal area 716 further includes an unsealed area that is exterior to heat seal 710 along a periphery or a border of packaging film 702. In other words, in some embodiments, non-heat seal area 716 includes an unsealed area that at least partially surrounds heat seal 710 along the periphery or the border of packaging film 702. Non-heat seal area 716 is greater than heat seal area 714. As illustrated in FIGS. 7A-7C, heat-resistant coating 708 is applied only in heat seal area 714 of packaging film 702. In some embodiments, heat-resistant coating 708 is at least partially coextensive with heat seal area 714. In some embodiments, heat-resistant coating 708 and heat seal area 714 have the same spatial or temporal scope, or the same boundaries. In other words, heat-resistant coating 708 and heat seal area 714 align over a same area. In some embodiments, heat-resistant coating 708 is coextensive with at least 75% of heat seal area 714. In some other embodiments, heat-resistant coating 708 is coextensive with at least 90% of heat seal area 714. In some other embodiments, heat-resistant coating 708 is coextensive with at least 95%, at least 96%, at least 97%, at least 98%, or at least 95% of heat seal area 714.

Further, heat seal 710 connects second surface 706 of packaging film 702 to a third surface 712. In this embodiment, third surface 712 is included in a second packaging component 702A. As shown in FIG. 7C, second packaging component 702A is adjacent to second surface 706 of packaging film 702. In some embodiments, second packaging component 702A may be substantially similar to packaging film 702. In some embodiments, second packaging component 702A may be different from packaging film 702.

Referring to FIGS. 7A-7C, packaging film 702 includes heat-resistant coating 708 only in the critical areas including less than 50%, by area, of first surface 704 of packaging film 702. Specifically, heat-resistant coating 708 may be applied only on heat seal area 714 which may come in direct contact with hot sealing jaws of a heat-sealing apparatus during a typical heat-sealing process on the packaging lines. Such partial application of heat-resistant coating 708 only in the critical areas of packaging film 702 may improve heat stability and heat resistance of packaging film 702 while retaining recycling properties of packaging film 702. In other words, packaging film 702 may limit the use of heat-resistant coating 708, which may otherwise hinder the NIR optical sorting in the polyolefin recycling process, only in the critical areas of packaging film 702 while improving the heat stability and heat resistance of packaging film 702. Thus, packaging film 702 may be sorted appropriately.

Further, such partial application of heat-resistant coating 708 only in the critical areas of packaging film 702 may reduce the amount of non-polyolefin-based polymers in packaging film 702. This may further reduce non-polyolefin-based polymer contamination in the recycling streams. Thus, packaging film 702 having a reduced amount of non-polyolefin-based polymers may provide a better quality recyclate.

In addition, as heat-resistant coating 708 is coextensive with less than 50%, by area, of first surface 704 of packaging film 702, packaging film 702 may be easier to manufacture as it may require less heat-resistant coating 708 for manufacture of packaging film 702. This may also further reduce the cost of manufacturing of packaging film 702.

Furthermore, as heat-resistant coating 708 is coextensive with less than 50%, by area, of first surface 704 of packaging film 702, the stresses exerted on packaging film 702 during manufacture of packaging film 702 may be substantially reduced. Further, less heat may be required for drying heat-resistant coating 708 during the coating process. This may reduce strain and/or shrinkage of packaging film 702. This may further allow usage of heat-resistant coating 708 on polyolefin substrates having limited or low heat stability but providing better mechanical performance, such as puncture resistance, drop resistance, or toughness. The polyolefin substrates having limited heat stability include, for example, oriented or non-oriented LDPE or LLDPE-based films.

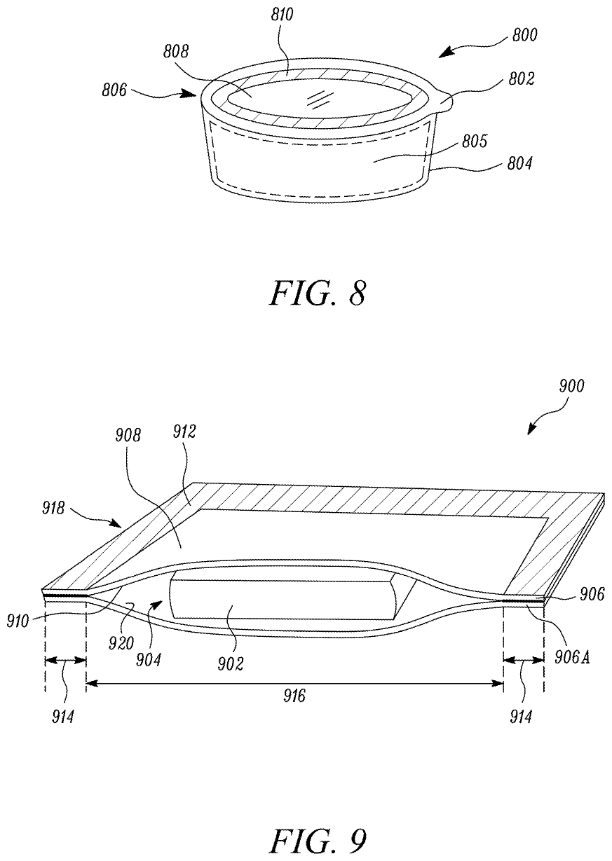

FIG. 8 is a schematic view of another package 800 in accordance with an embodiment of the present disclosure. Package 800 is equivalent to package 700. However, package 800 has a different configuration. In the illustrated embodiment of FIG. 8, package 800 has a cup-lid configuration. Package 800 includes a lid 802 placed on a cup 804 storing a product 805. Lid 802 covers cup 804 completely and may prevent leakage of product 805 from cup 804. Lid 802 may have any suitable shape, for example, a rectangular shape, a square shape, an oval shape, a triangular shape, a polygonal shape, a circular shape, or an elliptical shape depending on both functional and aesthetic requirements. The cup-lid configuration may be used to store food items such as butter, yoghurt, vegetable puree, jam, etc. However, in some other embodiments, package 800 may include other than the food items, such as paints, medicines, etc.

Further, lid 802 of package 800 includes a packaging film 806. Packaging film 806 is substantially equivalent to packaging film 100 (shown in FIGS. 1A-1C). However, in some other examples, package 800 may include any one of packaging films 200, 300, 400, 500, 600 (shown in FIGS. 2 to 6).

Packaging film 806 includes a first surface 808 and a second surface (not shown). First surface 808 includes the first polyolefin-based polymer and the second surface includes the second polyolefin-based polymer. Packaging film 806 further includes a heat-resistant coating 810 attached to first surface 808. Heat-resistant coating 810 is partially applied on first surface 808 along a periphery or near borders of packaging film 806. As is apparent from the illustrated embodiment of FIG. 8, heat-resistant coating 810 is coextensive with less than 50%, by area, of first surface 808 of packaging film 806.

FIG. 9 is a schematic view of another package 900 in accordance with an embodiment of the present disclosure. Package 900 is equivalent to package 700. However, package 900 has a different configuration. In the illustrated embodiment of FIG. 9, package 900 has a sachet-like configuration. Package 900 is used to contain a product 902 in a primary product cavity 904. In the sachet-like configuration, package 900 may not be heat sealed from at least one side such that product 902 inside primary product cavity 904 may be easily taken out from package 900 when desired.

Package 900 further includes a packaging film 906. Packaging film 906 is substantially equivalent to packaging film 100 (shown in FIGS. 1A-1C). However, in some other examples, package 900 may include any one of packaging films 200, 300, 400, 500, 600 (shown in FIGS. 2 to 6).

Packaging film 906 includes a first surface 908 and a second surface 910. First surface 908 includes the first polyolefin-based polymer and second surface 910 includes the second polyolefin-based polymer. Packaging film 906 further includes a heat-resistant coating 912 attached to first surface 908.

Packaging film 906 includes a heat seal 918 connecting second surface 910 of packaging film 906 to a third surface 920. In this embodiment, third surface 920 is included in a second packaging component 906A. As shown in FIG. 9, second packaging component 906A is adjacent to second surface 910 of packaging film 906. In some embodiments, second packaging component 906A may be substantially similar to or identical to packaging film 906. In some embodiments, second packaging component 906A may be different from packaging film 906.

Packaging film 906 further includes a heat seal area 914 and a non-heat seal area 916. Non-heat seal area 916 is greater than heat seal area 914. Heat seal area 914 is defined by heat seal 918. Heat-resistant coating 912 is at least partially coextensive with heat seal area 914. As is apparent from the illustrated embodiment of FIG. 9, heat-resistant coating 912 attached to first surface 908 is coextensive with more than 75% of heat seal area 914 of packaging film 906. Further, heat-resistant coating 912 is coextensive with less than 50%, by area, of first surface 908 of packaging film 906.

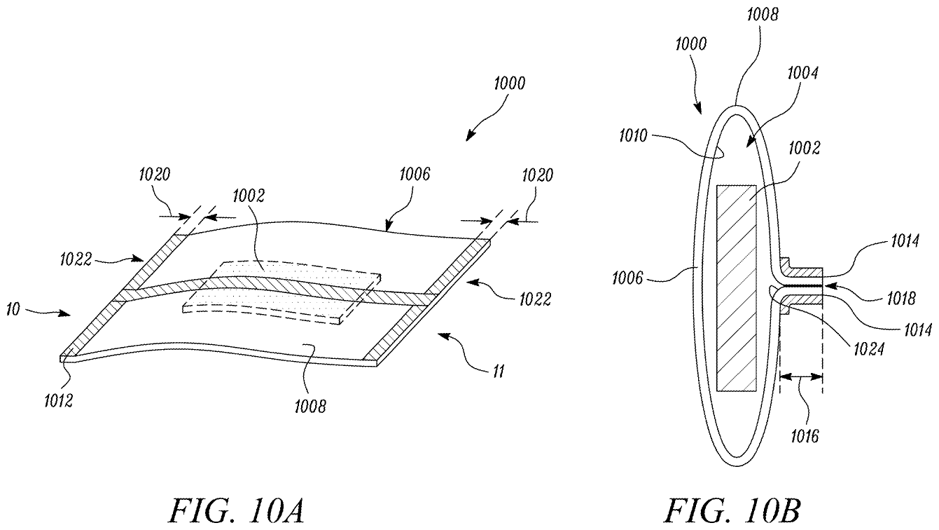

FIG. 10A is a schematic view of another package 1000 in accordance with an embodiment of the present disclosure. Package 1000 is equivalent to package 700. However, package 1000 has a different configuration. In the illustrated embodiment of FIG. 10A, package 1000 has a flow-wrap configuration. FIG. 10B is a cross-sectional view of package 1000.

Referring to FIGS. 10A and 10B, package 1000 is used to contain a product 1002 in a primary product cavity 1004. Package 1000 further includes a packaging film 1006. Packaging film 1006 is substantially equivalent to packaging film 100 (shown in FIGS. 1A-1C). However, in some other examples, package 1000 may include any one of packaging films 200, 300, 400, 500, 600 (shown in FIGS. 2 to 6).

Packaging film 1006 includes a first surface 1008 and a second surface 1010. First surface 1008 includes the first polyolefin-based polymer and second surface 1010 includes the second polyolefin-based polymer. Packaging film 1006 further includes a heat-resistant coating 1012 attached to first surface 1008.

In the flow-wrap configuration, outer edges 1014 of packaging film 1006 overlap forming a tubular shape. Packaging film 1006 includes a heat seal 1018 connecting outer edges 1014 of packaging film 1006. Specifically, heat seal 1018 connects second surface 1010 of packaging film 1006 to a third surface 1024. In this embodiment, package 1000 has the flow-wrap configuration and third surface 1024 is second surface 1010 of packaging film 1006. Packaging film 1006 is folded to dispose two portions of second surface 1010 adjacent to each other. One of the two portions is third surface 1024. A heat seal area 1016 is defined by heat seal 1018. Therefore, outer edges 1014 of packaging film 1006 include the heat seal area 1016.

Package 1000 further includes a top side 10 and a bottom side 11. Packaging film 1006 may further include other heat seals 1022 in respective top and bottom sides 10, 11 of package 1000. Packaging film 1006 may further include heat seal areas 1020 defined by respective heat seals 1022. In some embodiments, heat-resistant coating 1012 may further be at least partially coextensive with heat seal areas 1020.

### EXAMPLES AND DATA

The following examples are offered for illustrative purposes only and is not intended to limit the scope of the claims in any way. Indeed, various modifications of the disclosure in addition to those shown and described herein will become apparent to those skilled in the art from the foregoing description and the following examples and fall within the scope of the appended claims.

### Example 1

A packaging film with a 3-layer structure was produced. The 3-layer structure included an inner layer, a middle layer, and an outer web. The inner layer included a standard low seal initiation temperature (SIT) polyethylene (PE) sealant. A thickness of the inner layer was about 60 microns. Each of the middle layer and the outer web included an oriented polypropylene (OPP) layer. The OPP layer was a standard non-sealable biaxially oriented polypropylene (BOPP) layer with an exterior homopolymer polypropylene layer. A thickness of each of the middle layer and the outer web was about microns.

A first heat-resistant coating, and a second heat-resistant coating were taken for further experiment. Components and mix ratio of the first and second heat-resistant coatings are shown in Table 1 provided below.

TABLE 1

| | | | | | Dry Coat | |
|---|---|---|---|---|---|---|
| | | | Mix | | Weight | Adhesion |
| | Provider | Components | Ratio | Finish | (g/m²) | Test |
| First | Siegwerk | 1) BG 2K 100 | 100:100 | Glossy | 2.0 | OK |
| heat-resistant | | 2) Aromatic | | | | |
| coating | | hardener Härter 14 | | | | |
| Second | Bostik | 1) GL 3335 | 100:50 | Glossy | 1.7 | OK |
| heat-resistant | | 2) GU106 | | | | |
| coating | | | | | | |

In further experiment, the packaging film was coated with the first and second heat-resistant coatings to form a second packaging film and a third packaging film, respectively. Specifically, the outer web of each of the first packaging film was coated with the first and second heat-resistant coatings, respectively. The original uncoated packaging film (the first packaging film) was compared with the second, and third packaging films on the basis of slip properties and sealing temperatures.

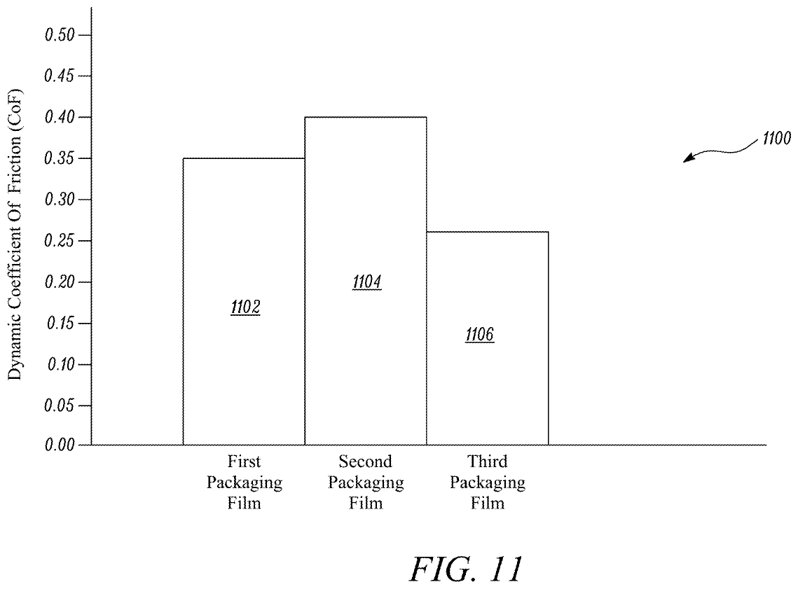

FIG. 11 is a graph 1100 illustrating dynamic coefficient of friction (CoF) of the first, second, and third packaging films. Graph 1100 includes an axis of ordinates representing the dynamic CoF. As used herein, dynamic CoF is measured according to ASTM D-1894 “Standard Test Method for Static and Kinetic Coefficients of Friction of Plastic Film and Sheeting”. The dynamic CoF as reported was measure using a speed of 150 mm/min. Graph 1100 further includes a first bar 1102, a second bar 1104, and a third bar 1106. First bar 1102 depicts the dynamic CoF of the first packaging film without any heat-resistant coating. Second bar 1104 depicts the dynamic CoF of the first packaging film with the first heat-resistant coating (shown in Table 1), i.e., the second packaging film. Third bar 1106 depicts the dynamic CoF of the first packaging film with the second heat-resistant coating (shown in Table 1), i.e., the third packaging film.

As is apparent from graph 1100, third bar 1106 is lower than each of first and second bars 1102, 1104. Therefore, the dynamic CoF of the third packaging film with the second heat-resistant coating was lower than the dynamic CoF of the first and second packaging films. Further, slip properties can be determined by the dynamic CoF. The slip is inversely proportional to the dynamic CoF. Therefore, the slip of the third packaging film with the second heat-resistant coating was higher than the first and second packaging films. Further, the second packaging film with the first heat-resistant coating had a higher dynamic CoF than the first packaging film without any heat-resistant coating. In other words, the second packaging film with the first heat-resistant coating had a lower slip than the first packaging film without any heat-resistant coating. This shows that depending on the application, slip properties can be adjusted by the choice of the appropriate heat-resistant coating.

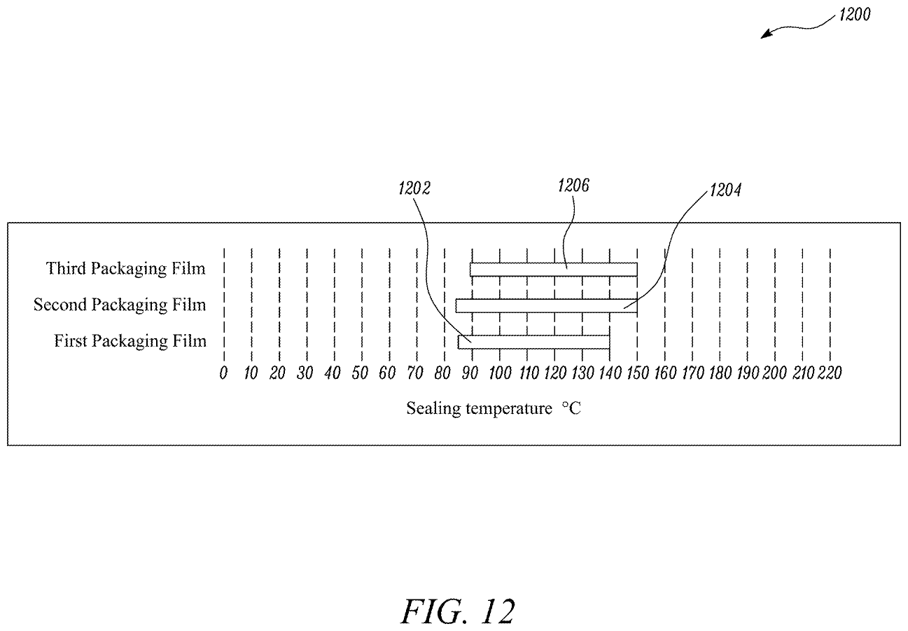

FIG. 12 is a graph 1200 illustrating a sealing temperature window of the first, second, and third packaging films. As used herein the sealing temperature window for a given film is determined by the result of two tests. The first test is the HSIT determination as previously described. The HSIT is the lower limit of the sealing temperature window. The second test is a thermo resistance test that is conducted similar to the heat seal creation portion of the HSIT test. Heat seal test equipment is fit with 2 heated seal bars. The film is sealed to itself (sealing surface to sealing surface) at conditions of 200 N/10 cm² for 0.5 seconds. The seal area and the area of the film surrounding the seal is visually evaluated. The heat sealing temperature of the thermo resistance test is increased until visual inspection of the seal area reveals deformation and shrinking of the film or if the area around the seal becomes significantly curvy and deformed. The point at which these defects become evident is the upper limit of the sealing temperature window.

Graph 1200 includes an axis of abscissas representing the sealing temperature in degree centigrade (° C.). Graph 1200 further includes a first bar 1202, a second bar 1204, and a third bar 1206. First bar 1202 depicts the sealing temperature window of the first packaging film without any heat-resistant coating. Second bar 1204 depicts the sealing temperature window of the first packaging film with the first heat-resistant coating (shown in Table 1), i.e., the second packaging film. Third bar 1206 depicts the sealing temperature window of the first packaging film with the second heat-resistant coating (shown in Table 1), i.e., the third packaging film.

As is apparent from graph 1200, the sealing temperature window of each of the second and third packaging films was greater than the sealing temperature window of the first packaging film. Therefore, the sealing temperature window of the first packaging film is extended on application of the first and second heat-resistant coatings. In other words, the sealing temperature window of the first packaging film without any heat-resistant coating is less than the sealing temperature window of each of the second and third packaging films with the first and second heat-resistant coatings, respectively. The sealing temperature windows of the second and third packaging films with the first and second heat-resistant coatings, respectively, were extended by about 10° C., when compared to the sealing temperature window of the first packaging film without any heat-resistant coating. However, the Seal Initiation Temperatures (SITs) of the first, second, and third packaging films were substantially similar. Specifically, the SITs of the first, second, and third packaging films were between about 85° C. and about 89° C.

### Example 2

A packaging film with a 2-layer structure was produced. The 2-layer structure included an inner layer and an outer web. The inner layer included a PE layer, and the outer web included a machine direction-oriented (MDO) PE layer. The PE layer was a standard low SIT PE sealant. A thickness of the PE layer was about 60 microns. The MDOPE layer was a standard HDPE-rich MDOPE. A thickness of the MDOPE layer was about 25 microns.

The second heat-resistant coating was taken for further experiment. Components and mix ratio of the second heat-resistant coating are shown in Table 2 provided below.

TABLE 2

| | | | | Dry Coat | |
|---|---|---|---|---|---|
| | | Mix | | Weight | Adhesion |
| Provider | Components | Ratio | Finish | (g/m²) | Test |
| Bostik | 1) GL 3335 | 100:50 | Glossy | 1.6 to 1.9 | OK |
| | 2) GU106 | | | | |

In further experiment, the 2-layer packaging films (the fourth packaging film) was coated with the second heat-resistant coating to form a fifth packaging film. Specifically, the outer web of the 2-layer packaging film was coated with the second heat-resistant coating to form the fifth packaging film. The slip properties and sealing temperatures were measured for the fifth packaging film.

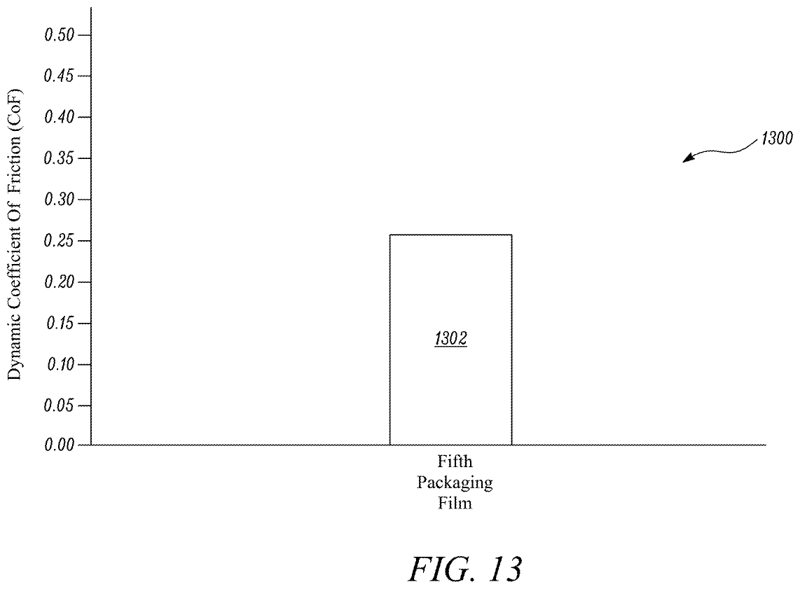

FIG. 13 is a graph 1300 illustrating the dynamic CoF of the fifth packaging film. Graph 1300 includes an axis of ordinates representing the dynamic CoF. Graph 1300 further includes a bar 1302. The bar 1302 depicts the dynamic CoF of the fourth packaging film with the second heat-resistant coating (shown in Table 2), i.e., the fifth packaging film. The same test was run on the fourth packaging film without the heat-resistant coating and the dynamic CoF was 0.26. The heat-resistant coating did not impact the slip properties significantly.

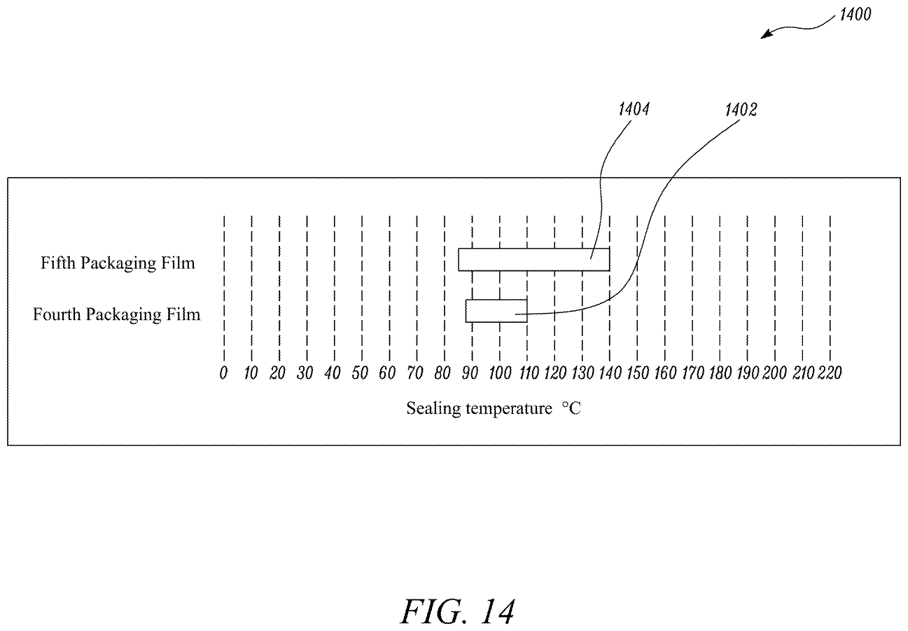

FIG. 14 is a graph 1400 illustrating a sealing temperature window of the fourth and fifth packaging films. Graph 1400 includes an axis of abscissas representing the sealing temperature in degree centigrade (° C.). Graph 1400 further includes a first bar 1402 and a second bar 1404. First bar 1402 depicts the sealing temperature window of the fourth packaging film without any heat-resistant coating. Second bar 1404 depicts the sealing temperature window of the fourth packaging film with the second heat-resistant coating (shown in Table 2), i.e., the fifth packaging film.

As is apparent from graph 1400, the sealing temperature window of the fifth packaging film was greater than the sealing temperature window of the fourth packaging film. Therefore, the sealing temperature window of the fourth packaging film is extended on application of the second heat-resistant coating. In other words, the sealing temperature window of the fourth packaging film without any heat-resistant coating is less than the sealing temperature window of the fifth packaging film with the second heat-resistant coating. The sealing temperature window of the fifth packaging film with the second heat-resistant coating was extended by about 30° C., when compared to the sealing temperature window of the fourth packaging film without any heat-resistant coating. However, the SITs of the fourth and fifth packaging films were substantially similar. Specifically, the SITs of the fourth and fifth packaging films were between about 85° C. and about 89° C.

In conclusion, the second heat-resistant coating had a good adhesion on the first and fourth packaging films with good slip properties. Further, applying a relatively small amount of the second heat-resistant coating (1.5-2.0 g/m²) on the first and fourth packaging films tackled the heat stability issues along with moving an upper limit of the sealing temperature window of the first and fourth packaging films to a significant extent.

Therefore, packaging film 100, 200, 300, 400, 500, 600, 702, 806, 906, 1006 includes heat-resistant coating 106, 206, 306, 406, 506, 606, 708, 810, 912, 1012 only in the critical areas including less than 50%, by area, of first surface 102, 202, 302, 402, 502, 602, 704, 808, 908, 1008 of packaging film 100, 200, 300, 400, 500, 600, 702, 806, 906, 1006. Specifically, heat-resistant coating 106, 206, 306, 406, 506, 606, 708, 810, 912, 1012 may be present only in the critical areas which come in direct contact with hot sealing jaws under pressure during the heat-sealing process on the packaging lines. Such partial application of heat-resistant coating 106, 206, 306, 406, 506, 606, 708, 810, 912, 1012 only in the critical areas of packaging film 100, 200, 300, 400, 500, 600, 702, 806, 906, 1006 may improve heat stability and heat resistance of packaging film 100, 200, 300, 400, 500, 600, 702, 806, 906, 1006 while retaining recycling properties of packaging film 100, 200, 300, 400, 500, 600, 702, 806, 906, 1006. In other words, packaging film 100, 200, 300, 400, 500, 600, 702, 806, 906, 1006 may limit the use of heat-resistant coating 106, 206, 306, 406, 506, 606, 708, 810, 912, 1012, which may otherwise hinder the NIR optical sorting in the polyolefin recycling process, only in the critical areas of packaging film 100, 200, 300, 400, 500, 600, 702, 806, 906, 1006 while improving the heat stability and heat resistance of packaging film 100, 200, 300, 400, 500, 600, 702, 806, 906, 1006. Thus, packaging film 100, 200, 300, 400, 500, 600, 702, 806, 906, 1006 may be recyclable. Further, such partial application of heat-resistant coating 106, 206, 306, 406, 506, 606, 708, 810, 912, 1012 only in the critical areas of packaging film 100, 200, 300, 400, 500, 600, 702, 806, 906, 1006 may reduce the amount of non-polyolefin-based polymer in packaging film 100, 200, 300, 400, 500, 600, 702, 806, 906, 1006. This may further reduce non-polyolefin-based polymer contamination in the recycling streams. Packaging film 100, 200, 300, 400, 500, 600, 702, 806, 906, 1006 having a reduced amount of non-polyolefin-based polymers may therefore provide a better quality recyclate.

Furthermore, as heat-resistant coating 106, 206, 306, 406, 506, 606, 708, 810, 912, 1012 is coextensive with less than 50%, by area, of first surface 102, 202, 302, 402, 502, 602, 704, 808, 908, 1008 of packaging film 100, 200, 300, 400, 500, 600, 702, 806, 906, 1006, the stresses exerted on packaging film 100, 200, 300, 400, 500, 600, 702, 806, 906, 1006 during the manufacturing of packaging film 100, 200, 300, 400, 500, 600, 702, 806, 906, 1006 may be substantially reduced. Further, less heat may be required for drying heat-resistant coating 106, 206, 306, 406, 506, 606, 708, 810, 912, 1012 during the coating process when using water-based or solvent-based heat resistant coatings. This may reduce strain and/or shrinkage of packaging film 100, 200, 300, 400, 500, 600, 702, 806, 906, 1006.

This may further allow usage of heat-resistant coatings 106, 206, 306, 406, 506, 606, 708, 810, 912, 1012 on polyolefin substrates (for example, oriented or non-oriented LDPE/LLDPE-based films) having low or limited heat stability but providing better mechanical performance, such as puncture resistance, drop resistance, or toughness.

In addition, as relatively small amount of heat-resistant coating 106, 206, 306, 406, 506, 606, 708, 810, 912, 1012 is used for the manufacturing of packaging film 100, 200, 300, 400, 500, 600, 702, 806, 906, 1006, the cost of manufacturing of packaging film 100, 200, 300, 400, 500, 600, 702, 806, 906, 1006 may also be reduced.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

Unless otherwise indicated, all numbers expressing sizes, amounts, ranges, limits, and physical and other properties used in the present application are to be understood as being preceded in all instances ay the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

As used in the present application, the singular forms “a”, “an”, and “the” encompass embodiments having plural referents, unless the context clearly dictates otherwise. As used in the present application, the term “or” is generally employed in its sense including “and/or”, “unless” the context clearly dictates otherwise.

Spatially related terms, including but not limited to, “lower”, “upper”, “beneath”, “below”, “above”, “bottom” and “top”, if used in the present application, are used for ease of description to describe spatial relationships of an element(s) to another. Such spatially related terms encompass different orientations of the device in use or operation, in addition to the particular orientations depicted in the figures and described in the present application. For example, if an object depicted in the drawings is turned over or flipped over, elements previously described as below, or beneath other elements would then be above those other elements.

The drawings show some but not all embodiments. The elements depicted in the drawings are illustrative and not necessarily to scale, and the same or similar) reference numbers denote the same (or similar) features throughout the drawings.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

### EMBODIMENTS

A. A packaging film comprising:
a first surface comprising a first polyolefin-based polymer;
a second surface comprising a second polyolefin-based polymer; and
a heat-resistant coating attached to the first surface, wherein the heat-resistant coating is coextensive with less than 50%, by area, of the first surface of the packaging film.

B. The packaging film according to Embodiment A, comprising a first polyethylene-based film comprising the first surface.

C. The packaging film according to Embodiment A, comprising a first oriented polyethylene-based film comprising the first surface.

D. The packaging film according to Embodiment A, comprising a first polypropylene-based film comprising the first surface.

E. The packaging film according to Embodiment A, comprising a first oriented polypropylene-based film comprising the first surface.

F. The packaging film according to any previous Embodiment, the second polyolefin-based polymer is a second polyethylene-based polymer or a second polypropylene-based polymer.

G. The packaging film according to any previous Embodiment, wherein the second polyolefin-based polymer of the second surface is a polyethylene-based polymer having a heat seal initiation temperature (HSIT) less than 110° C.

H. The packaging film according to any Embodiment A-F, wherein the second polyolefin-based polymer of the second surface is a polypropylene-based polymer having a HSIT less than 140° C.

I. The packaging film according to any previous Embodiment, wherein the total composition of the packaging film is at least 80% polyolefin-based polymer, by weight.

J. The packaging film according to any previous Embodiment, wherein the heat-resistant coating has a dry coat weight of between 0.5-4.0 g/m².

K. The packaging film according to any previous Embodiment, further comprising an internal layer comprising a high-density polyethylene polymer.

L. The packaging film according to any previous Embodiment, further comprising an internal layer comprising a barrier material, wherein the barrier material is one or more of polyamide-based polymer, cyclic olefin copolymer, ethylene vinyl alcohol copolymer, acrylic, polyvinyl alcohol copolymer, metal, aluminum oxide, and silicon oxide.

M. A package comprising the packaging film according to any Embodiment herein and a heat seal connecting the second surface of the packaging film to a third surface.

N. The package according to Embodiment M, wherein the packaging film further comprises a heat seal area defined by the heat seal and the heat-resistant coating is coextensive with at least 75% of the heat seal area.

O. The package according to Embodiment M or N, wherein the packaging film further comprises a heat seal area defined by the heat seal and the heat-resistant coating is coextensive with at least 90% of the heat seal area.

P. A package comprising a packaging film comprising:
a first surface comprising a first polyolefin-based polymer;
a second surface comprising a second polyolefin-based polymer;
a heat seal area defined by a heat seal, the heat seal connecting the second surface of the packaging film to a third surface; and
a heat-resistant coating attached to the first surface and at least partially coextensive with the heat seal area.

Q. The package according to Embodiment P, wherein the heat-resistant coating attached to the first surface is coextensive with more than 75% of the heat seal area of the packaging film, and wherein the heat-resistant coating is coextensive with less than 50%, by area, of the first surface of the packaging film.

R. The package according to Embodiment P or Q, wherein the package has a pillow bag configuration and the third surface is the second surface of the packaging film.

S. The package according to Embodiment P or Q, wherein the third surface is comprised in a second packaging component.

T. The package according to any of Embodiments P-S, wherein the total composition of the packaging film is at least 80% polyolefin-based polymer, by weight.

1. A packaging film comprising:
a first surface comprising a first polyolefin-based polymer;
a second surface comprising a second polyolefin-based polymer; and
a heat-resistant coating attached to the first surface, wherein the heat-resistant coating is coextensive with less than 50%, by area, of the first surface of the packaging film.

2. The packaging film according to claim 1, comprising a first polyethylene-based film comprising the first surface.

3. The packaging film according to claim 1, comprising a first oriented polyethylene-based film comprising the first surface.

4. The packaging film according to claim 1, comprising a first polypropylene-based film comprising the first surface.

5. The packaging film according to claim 1, comprising a first oriented polypropylene-based film comprising the first surface.

6. The packaging film according to claim 1, the second polyolefin-based polymer is a second polyethylene-based polymer or a second polypropylene-based polymer.

7. The packaging film according to claim 1, wherein the second polyolefin-based polymer of the second surface is a polyethylene-based polymer having a heat seal initiation temperature (HSIT) less than 110° C.

8. The packaging film according to claim 1, wherein the second polyolefin-based polymer of the second surface is a polypropylene-based polymer having a HSIT less than 140° C.

9. The packaging film according to claim 1, wherein the total composition of the packaging film is at least 80% polyolefin-based polymer, by weight.

10. The packaging film according to claim 1, wherein the heat-resistant coating has a dry coat weight of between 0.5-4.0 g/m².

11. The packaging film according to claim 1, further comprising an internal layer comprising a high-density polyethylene polymer.

12. The packaging film according to claim 1, further comprising an internal layer comprising a barrier material, wherein the barrier material is one or more of polyamide-based polymer, cyclic olefin copolymer, ethylene vinyl alcohol copolymer, acrylic, polyvinyl alcohol copolymer, metal, aluminum oxide, and silicon oxide.

13. A package comprising the packaging film according to claim 1 and a heat seal connecting the second surface of the packaging film to a third surface.

14. The package according to claim 13, wherein the packaging film further comprises a heat seal area defined by the heat seal and the heat-resistant coating is coextensive with at least 75% of the heat seal area.

15. The package according to claim 13, wherein the packaging film further comprises a heat seal area defined by the heat seal and the heat-resistant coating is coextensive with at least 90% of the heat seal area.

16. A package comprising a packaging film comprising:
a first surface comprising a first polyolefin-based polymer;
a second surface comprising a second polyolefin-based polymer;
a heat seal area defined by a heat seal, the heat seal connecting the second surface of the packaging film to a third surface; and
a heat-resistant coating attached to the first surface and at least partially coextensive with the heat seal area.

17. The package according to claim 16, wherein the heat-resistant coating attached to the first surface is coextensive with more than 75% of the heat seal area of the packaging film, and wherein the heat-resistant coating is coextensive with less than 50%, by area, of the first surface of the packaging film.

18. The package according to claim 16, wherein the package has a pillow bag configuration and the third surface is the second surface of the packaging film.

19. The package according to claim 16, wherein the third surface is comprised in a second packaging component.

20. The package according to claim 16, wherein the total composition of the packaging film is at least 80% polyolefin-based polymer, by weight.
